(19) United States
(12) Patent Application Publication
(10) Pub. No.: US 2004/0215501 A1
(43) Pub. Date: Oct. 28, 2004

(54) Method and system for automated marketing

(76) Inventor: Emmanuel d'Ornano, Saint Cloud (FR)

Correspondence Address: DORSEY & WHITNEY LLP, INTELLECTUAL PROPERTY DEPARTMENT, 250 PARK AVENUE, NEW YORK, NY, 10177, US

(21) Appl. No.: 10/421,769

(22) Filed: Apr. 24, 2003

(51) Int. Cl. G06F 17/60

(52) U.S. Cl. 705/10

(57) ABSTRACT

A method, and corresponding system, provide automated marketing with protection of customer nominative data in a network having importing and exporting nodes. At least one of the exporting nodes stores customer information desired by an importing node for use in automated marketing of a product or service. The method includes the steps, executed at the importing node, of formulating a discovery action, the discovery action requesting a description of the network, the description identifying exporting nodes in the network from which the importing node imports customer information, receiving the network description of the network, formulating a query directed to identified exporting nodes, the query requesting customer behavioral data, the query generating a campaign descriptor for each identified exporting node, receiving the campaign descriptor, creating a campaign based on the campaign descriptor, and extracting customer nominative data from the identified exporting nodes using coupons. The method further includes the steps, executed at each of the exporting nodes, of receiving the query, based on the query, extracting the customer behavioral data from a customer behavioral data database, and based on the extracted customer behavioral data, generating the campaign descriptor. The method still further includes the steps, executed at each of the identified exporting nodes, of sending the campaign descriptor to the network service, receiving the campaign, validating the campaign, generating the coupons, and sending the coupons to the network service.

### TECHNICAL FIELD

The technical field generally relates to systems and methods for automating marketing operations and managing usage rights on customer information. More particularly, the technical field relates to the management and monetization of customer information usage rights at the level of a network of business partners.

### BACKGROUND

According to 1993 Nobel Prize winner Douglas C. North, between 1870 and 1970 the share of transaction costs (i.e. the cost of economic agents interacting together) in the U.S. gross domestic product increased from 25.1% to more than 54.7%. In developed economies, interactions, the fact of matching offer and demand, be it between a company and its clients or between a government and its citizens, has become the primary economic function. Matching offer and demand is about having the right information at the right time, whereas this information comes by nature from outside of the organization's perimeter. For organizations, the lack of access to this information results in a dramatic increase in customer acquisition and related costs.

The overall performance of an organization regarding its interaction costs can be monitored through a global indicator of what may be termed transformation rate. The transformation rate measures the share of customer contacts that effectively translate into a transaction. The impact of the transformation rate on an organization's productivity can be significant. Current industry averages for marketing campaigns give transformation rate values from 0.5% to 1.5%. Improving the transformation rate from 1.5% to 2%, for example, increases the transaction margin by a factor of more than fifteen times the individual cost of contact.

The transformation rate can be improved by either reducing the number of overall contacts of the organization, or by increasing the number of successful contacts. Those two aims have been addressed so far mainly through data mining on internal data that, in the end, is weakly correlated to the outcome of the transaction. This hypothesis can be explained through the “firm's paradox”, which states: “Most of the time, a firm has access to client information only once the transaction has taken place. Hence the firm collects this information at the least critical moment, i.e., when the decision of transacting is already taken and implemented. To anticipate a purchase, the firm has to know the information that triggers the purchase, information that most of the time is located outside of the organization's perimeter.”

Poor transformation rates can also be explained by the commercial pressure that is imposed upon prospective customers. The average U.S. consumer, for example, receives roughly one million marketing messages a year across all media, or about 3,000 messages a day. The novel and unfettered dispersal of personal information gives a striking example of the limited ability of organizations to act in a cooperative manner. Sharing information is as much about knowing when to act as about knowing when not to act.

This analysis is supported by the evidence that the only marketing systems to report above-average transformation rates (approximately 6%) are behavioral networks, which enable to detect behavioral patterns across networks of organizations. However, the deployment of behavioral networks is hindered by three major obstacles: 1) the lack of an information usage enforcement mechanism, 2) a lack of a satisfying integration framework between organizations which requires ad-hoc and hence costly investments, and 3) the protection of privacy. As of today, no satisfying cross-industry implementation has been proposed to address those obstacles in an economically efficient manner.

### SUMMARY

What is disclosed is a method for automated direct marketing in a network that includes a network service center including a discovery service, a proxy server, and a log database. The method includes, at a first node in the network, retaining customer information, the customer information comprising nominative data and behavioral data, the nominative data providing identities of specific customers of a company and privacy data related to the specific customers, the behavioral data comprising customer propensity information, providing the behavioral data to a second node in the network, and locating the nominative data associated with the provided behavioral data.

Also disclosed is a system for automated direct marketing in a network comprising nodes and a service center, the service center including a proxy server, a discovery server, and a log database. The system comprises a first data structure comprising behavioral data of customers, a second data structure comprising nominative data of the customers, wherein the nominative data provides identities of specific customers of a company and privacy data related to the specific customers, the behavioral data comprises customer propensity information, a discovery request generator that analyzes the behavioral data and generates a network description, and coupons used to match the behavioral data to the nominative data.

Further disclosed is a method for automated marketing and customer information usage rights management on a network having at least one importing node and at least one exporting node. At least one of the exporting nodes stores customer information desired by at least one importing node for use in automated marketing of a product or service. The method includes the steps, executed at the importing node, of formulating a discovery action, the discovery action requesting a description of the network, the description identifying exporting nodes in the network from which the importing node can retrieve customer information, receiving the network description of the network, formulating a campaign and sending a campaign descriptor to the identified exporting nodes, the campaign descriptor being updated based on the behavioral data contained at each identified exporting node, receiving the campaign descriptor, optimizing the campaign descriptor and sending a request for coupons to each appropriate exporting node. The method further includes the steps, executed at each of the exporting nodes of receiving the campaign descriptor, based on the campaign descriptor, extracting the customer behavioral data from a customer behavioral data database, and based on the extracted customer behavioral data, updating the campaign descriptor. The method still further includes the steps, executed at each of the identified exporting nodes, of sending the campaign descriptor to the importing node, receiving the campaign, validating the campaign, generating the coupons, and sending the coupons to the importing node.

Also, what is disclosed is a system that provides automated marketing with customer information usage rights management. The system includes, at an importing node in a network, a user interface that generates messaging used to extract information from other nodes in the network, a first propensity model that generates probabilities related to purchasing products and services by customers of the importing node, a first secure database that stores first node customer nominative data, and a first behavioral database that stores first node customer behavioral data. The system further includes a network service comprising one or more additional nodes that receive imports and exports node generated messages. The network service includes a proxy services that process selected received messages, generate events, reroute messages to appropriate exporting nodes, and for the purpose of non-repudiation logs all events and messages.

Still further, what is disclosed is a computer readable medium comprising a data structure for storing customer information related to automated marketing in a network having importing nodes and exporting nodes. The data structure includes a relationship object (as in “Customer Relationship Management”) that stores the behavioral information of a customer in the context of its relationship with the company owning the node, and includes authorizations to access this customer behavioral information. The data structure also includes a communication object that defines communication channels available to contact the customer of the exporting nodes and the importing nodes, a propensity object that stores the specific behavioral information required to infer the probability of purchasing a product or service by the customer as well as the personalization criteria valuable for convincing the customer to purchase a product or service, a coupon object that identifies the specific customer information usage right agreed on between the exporting and importing node, a campaign object that defines a specific marketing plan and optionally relating to a group of coupons, and a customer object storing customer nominative information.

### DESCRIPTION OF THE DRAWINGS

The detailed description will refer to the following drawings, in which like numerals refer to like items, and in which:

FIG. 1 is a diagram of a network that provides customer privacy and automated marketing;

FIG. 2 is a conceptual diagram showing relationships between entities of the network of FIG. 1;

FIG. 3 is a diagram of a computer system linked into the network of FIG. 1;

FIGS. 4A-4H illustrate relationships between data objects used in the network of FIG. 1;

FIGS. 5-13 illustrate processes and data flows associated with automated marketing using the network of FIG. 1; and

FIG. 14 is a flowchart showing an embodiment of a method for automated marketing with customer privacy.

### DETAILED DESCRIPTION

Customer behavioral information has value. Knowing that a baby has just been born, that a child is going to college, that a family has just moved, that someone has just sold his or her car—these are all events that are predictive of near-term needs. When the appropriate company knows about these needs, the company can offer services using direct marketing, and can expect a much higher transformation rate on its offer than the company could achieve without the information.

Companies that make use of direct marketing know that certain events provide higher return opportunities for their products, and specialized companies and services exist that give access to this type of information. However, the processes and systems used to provide the information are highly dependent on human intervention. The companies that have information must provide database administrators to extract and transform of relevant data, and to package this data in a standard form. Intermediaries such as data brokers provide points of aggregation for data-selling companies. Data-selling companies also must provide data administrators to compile and publish their collections of data, and sales people to negotiate commercial exchange. Marketing agencies work with data purchasers to identify and find customer profiles that will have the highest probability of successful transformation, and these too must employ data knowledgeable sales people to help formulate and manage requests to data brokers.

Thus, a system and method that could automate the delivery of useful direct marketing data would be of great economic value. It would significantly diminish the cost of the data, and make it more timely. However, the problem with automation is one of allowing potential purchasers of data to identify useful customer profiles without providing personal (nominative) information about the customer. This is important for two reasons. First, nominative data allows a company to contact an individual (name, address, telephone number, etc.). Typically data-selling companies only want to rent this information, not sell it outright. Second, in many circumstances the exchange of nominative data is prohibited by law.

Systems and methods for automating marketing operations while managing usage rights on customer information are disclosed. The systems and methods provide management and monetization of customer information usage rights at the level of a network of business partners that are interested in marketing their goods and services to the customers of other partners in the network, therefore using the other partners as a marketing interface. To provide the required management of customer information usage rights, each customer can be defined by data sets: behavioral data and nominative data. Behavioral data describes general characteristics of the customer, such as demographic data, or propensity of making a specific purchase of a product or service. Nominative data are data that are unique to the customer, such as the customers' name and telephone number. The behavioral data are used to command the marketing operations of the business partners through the brokerage of customer information usage rights, which determine the course of action and the compensation of each partner. Once the customer information usage rights are established for a requesting partner, these customer information rights are brokered to the requesting partner in the form of a digital coupon, that stores digitally signed customer behavioral data and a description of the usage rights corresponding to this data, but no nominative data to which the requesting partner never has access through the said system. Each usage of the nominative data is in the end of the sole legal responsibility of the exporting node that should manipulate it himself or through a trusted tier which never has access to the customer behavioral data. In this way, nominative and behavioral data remain at all time strictly insulated from each other at any point on the network but at the exporting node, therefore providing the guarantee to the owner of the exporting node to keep control at all time over its customer information usage rights. Furthermore, as the system conveys only anonymous data, the synchronization of customer information from at least two databases requires a de-duplication key that can be only be generated at the customer touch point through a specific acquisition mechanism, which we refer to as the customer subscribing to an affiliation. That is to say by either the customer giving his or her explicit consent that his or her nominative information be compared between the two nodes, or by providing him or herself a de-duplication key known by one node to the other nodes (e.g. giving the air miles reference number to the phone company, the telephone number to the airline company, etc.). Hence each de-duplication key can be traced back to the explicit consent of the customer, which makes the method and system flexible yet compliant with the strictest privacy standards. At all time, each business partner keeps control over its customer data, and termination of a partnership leaves no remnant nominative data accessible by the terminated partner(s). Furthermore, the partners do not have to make their data models converge, as the network provides an abstraction layer in the form of propensity models. Thus, the methods and systems provide tools for efficiently managing a network of business alliances. Using these methods and tools, the business partners can significantly enhance their own transformation rate by incorporating many possible forms of cooperation into the formal structure of networks of organizations.

The gains resulting from building a collaborative network for optimizing interactions between organizations and customers are numerous, but such a network requires a utility function to automate the allocation of customer information usage rights and hence command the marketing operations of the partners. The total amount of customer information usage rights capitalized on a node can also be termed customer equity. The expected goal of a node owner might be, for example, to maximize the value of this equity, which is calculated by estimating the net present value of future gains from these usage rights. Therefore, in this case, the utility function might be the value of the client equity given the customer information usage rights at hand, or in a more simple manner, the expected outcome from the next customer contact. Each node might have one or many different utility functions, the allocation of customer information usage rights being in the end determined by the highest bidder. Overall, customer information usage rights are allocated on the network according to a utility function, which can be for example the expected gain from the outcome of the contact, and a set of rules, the partnerships.

By using the systems and methods for automating marketing operations while managing usage rights on customer information, companies can build, maintain or terminate partnerships based on the potential of their customer information databases. Configuring partnerships, targeting the best customers, managing contact elasticity on transformation rate and overall commercial pressure can all be addressed through the unifying problem of customer information usage rights management, monetization and allocation.

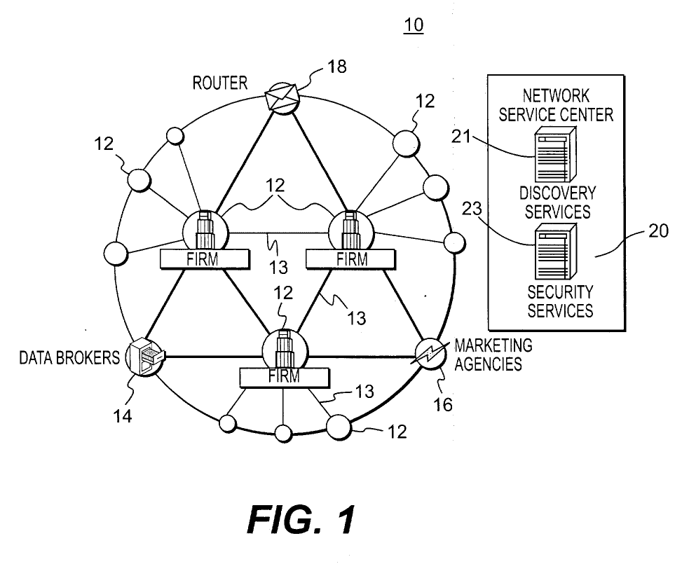

FIG. 1 illustrates a network 10 in which companies may share client information to promote sales and other activities between customers and companies. The network 10 solves the problem of customer information usage rights allocation through the use of a digital rights management tool applied to customer equity. The network 10 includes two or more companies 12 that communicate with each other using communication links 13. The companies 12 also communicate with data brokers 14 and marketing agencies 16. A router 18 is used to deliver direct marketing material to target customers. Also shown is a network service center 20 that provides discovery services 21 and security services 23. The links 13 in the network 10 may be of any currently known or future physical configuration including unshielded twisted pair (UTP) wire, coaxial cable, shielded twisted pair wire, fiber optic cable, for example. Alternatively, the links 13 may be wireless links.

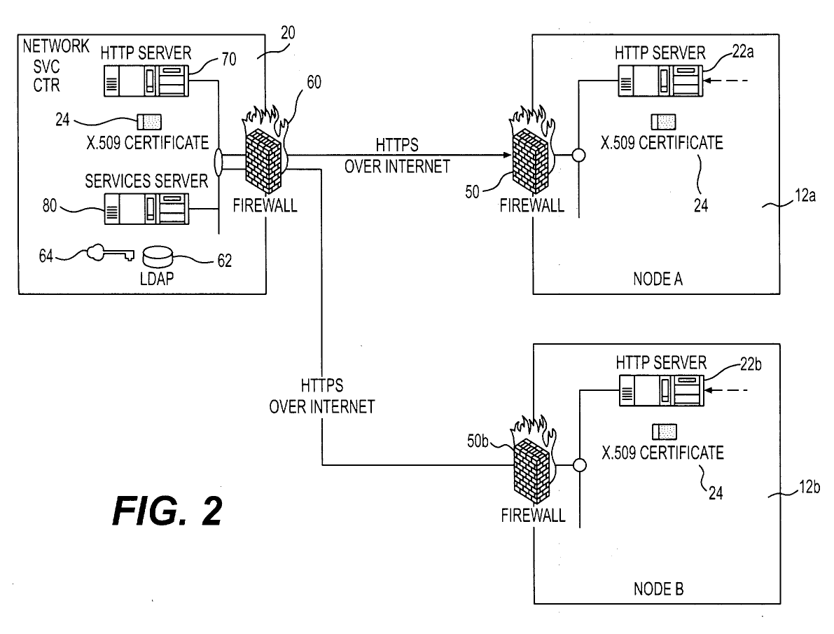

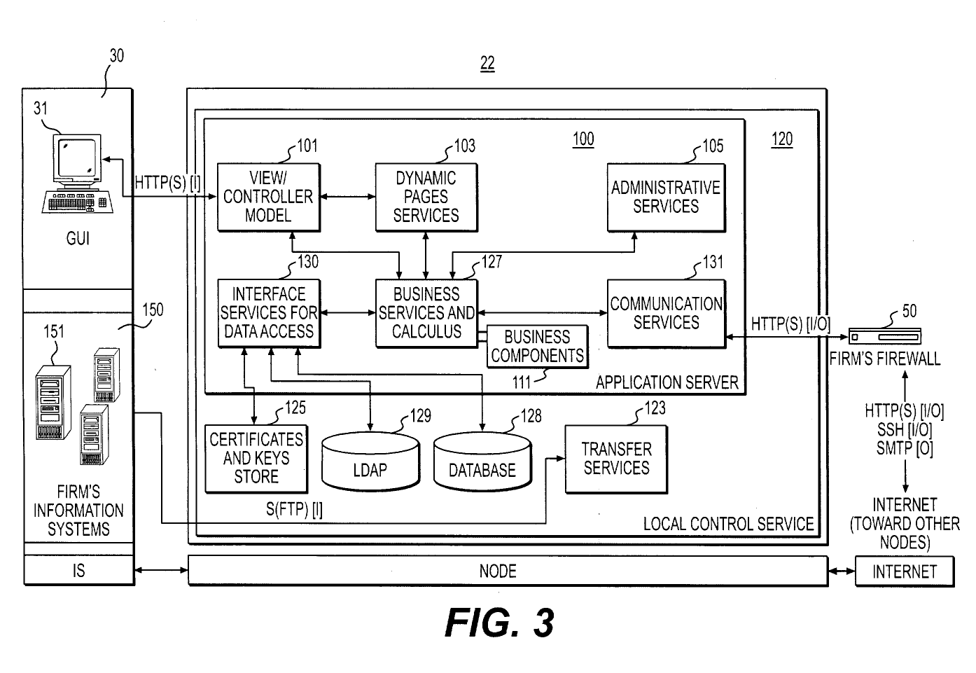

FIG. 2 is a conceptual diagram showing details of the network 10 of FIG. 1. In FIG. 2, company 12a (node A) and company 12b (node B) exist in the network 10 and are coupled to the service center 20. Companies 12a and 12b each include a firewall 50, which serves to isolate the company from entities outside the company. Each of the companies 12a and 12b also incorporates a computer system 22 and a certificate system 24. The computer system 22 will be described in more detail with reference to FIG. 3.

The service center 20 communicates with nodes in the network 10, such as node A (company 12a) and node B (company 12b) using HTTP over the Internet. The service center 20 includes a firewall 60, HTTP server 70, services server 80, certificate system 24, database 62, and private key/public key system 64. The HTTP server 70 is used to establish communications over the Internet, and the structure and operation of the HTTP server 70 is well known in the art. Similarly, the certificate system 24 and the public key/private key system 64 are also well know in the art.

In the discussions that follow, the use of the computer system 22, and other systems and services at the service center 20 will be explained by way of an example wherein company 12a (node A) is a credit card company, and company 12b (node B) is an automobile manufacturer. The automobile manufacturer (company 12b) has a customer list that includes many individuals whom the credit card company (company 12a) may want to contact in order to offer its credit services. Conversely, the automobile manufacturer 12b may want to access existing customers of the credit card company 12a in order to market its automobiles.

FIG. 3 is a diagram of the computer system 22 as implemented in the nodes of the network 10 (e.g. at companies 12a and 12b). The computer system 22 includes three general sections, a client information system (IS), a node, and the Internet. More specifically, the computer system 22 includes a processing system 120, customer computer system 30, information system 150, and the firewall 50. The firewall 50 was previously described with respect to FIG. 2. The customer computer system 30 includes the graphical user interface 31 that communicates with the processing system 120 using HTTP, for example. The information system 150 includes one or more computer devices 151 that store and process information related to the company 12.

The processing system 120 includes application server 100. The application server 100 includes a view/controller module 101, a dynamic page service module 103, administrative services module 105, interface 130, business services and calculus module 127, and communications services module 131. Coupled to the interface 130 are certificate and key storage 125, nominative database 129, and behavioral database 128. As will be described later, the behavioral database 128 may be used to store customer behavioral data. The nominative database 129 may be used to store customer nominative data. Coupled to the business services and calculus module 127 are the company's business components 111. The business components 111 include an interface from the company's unique business resources into the processing system 120. Each company 12 in the network 10 may have unique resources that the company 12 uses to gather information related to its customers, its industry, and operational aspects of its business. These resources may include company- or industry-specific models that are used to generate marketing campaigns, predict sales, and gather customer purchasing information, for example.

The communication services module 131 couples the node to other nodes in the network 10, using the firewall 50 to provide security for the node. Communications to and from the communication services module 131 through the firewall 50 may be by one or more of HTTP, SSH and SMTP protocols, or other existing or future communication protocols. A transfer services module 123 may communicate with the information system 150 using standard file transfer procedures.

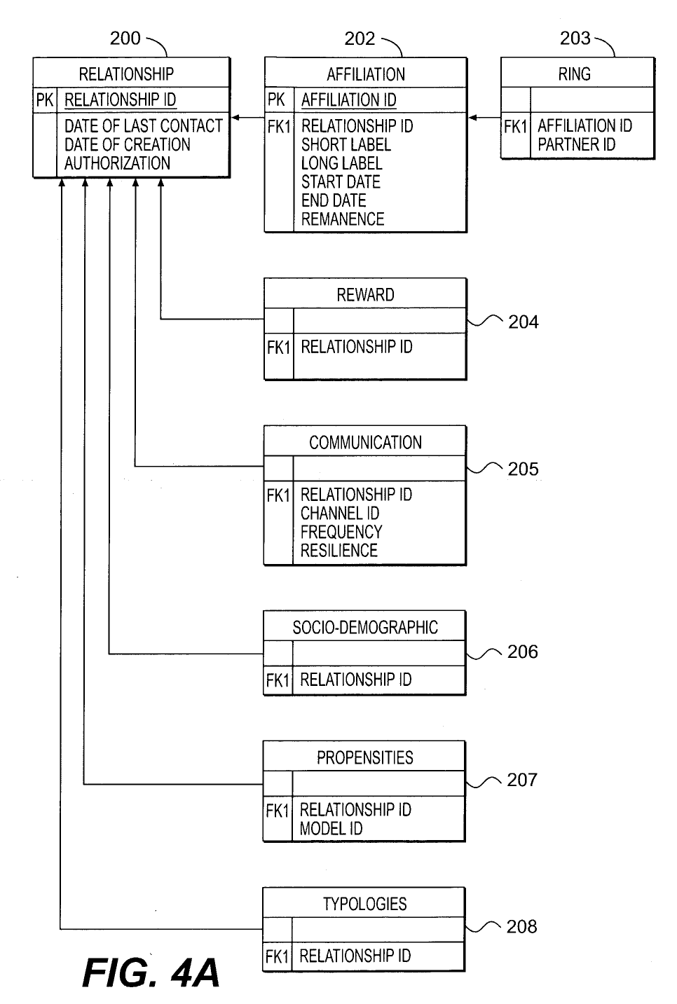

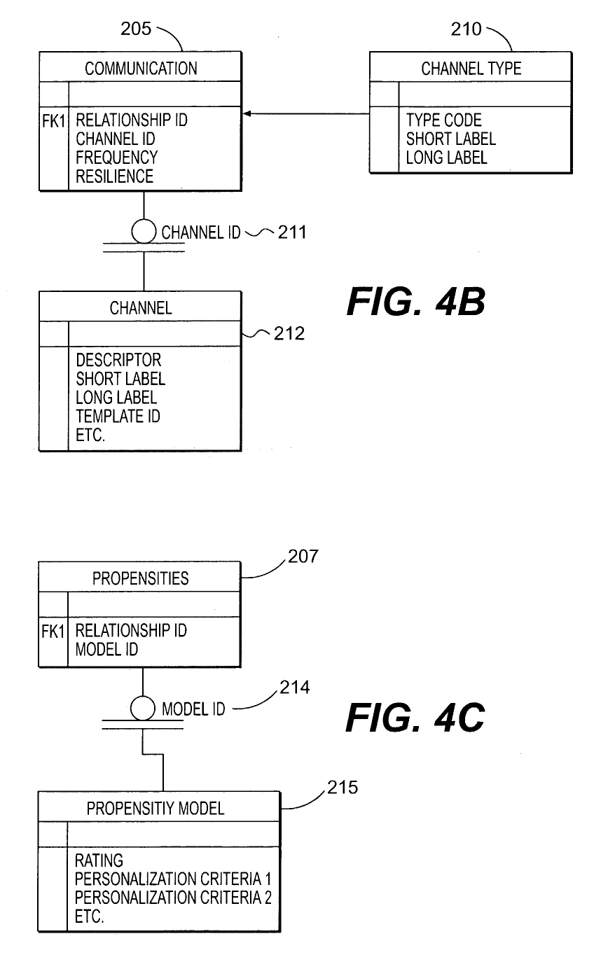

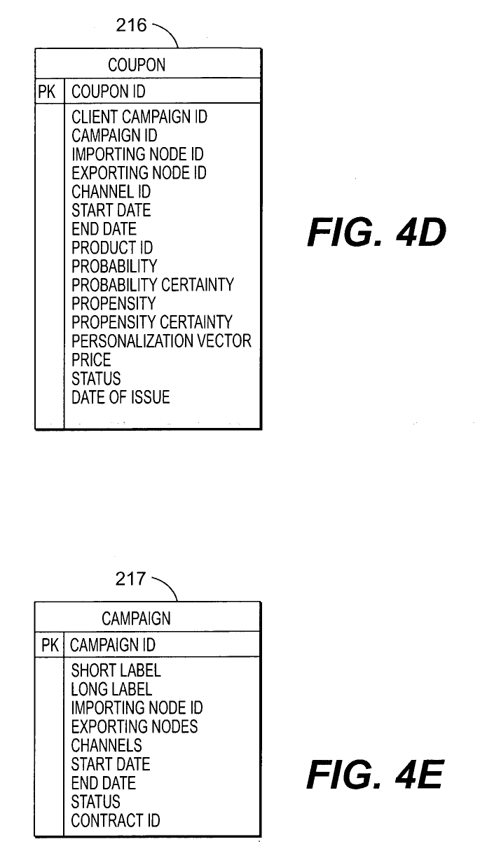

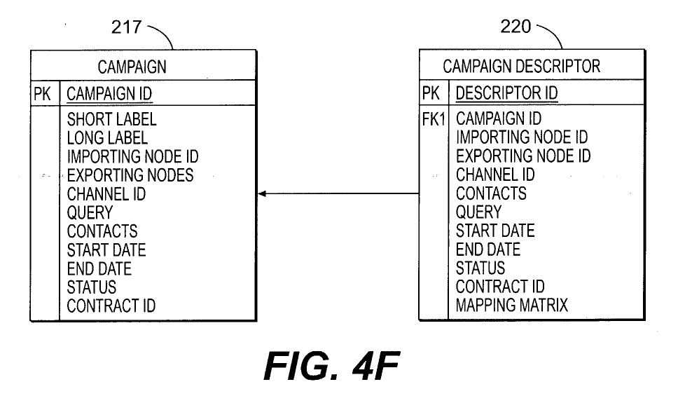

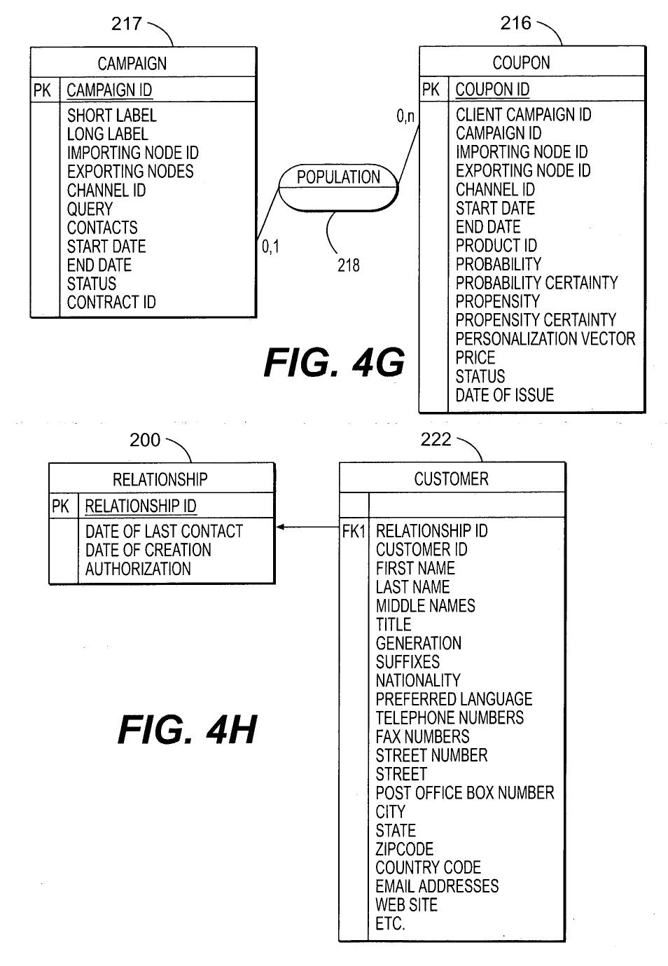

Each customer is linked to each company in the network 10 of FIG. 1 by a relationship, which may be represented as a data object. Each company in the network 10 can query the relationships of its business partners to identify prospective customers. Taking a specific example, the automobile manufacturer 12b and the credit card company 12a are each interested in marketing their products and services to the customers of the other company. A number of data objects are defined that allow execution of this cross-marketing opportunity. FIGS. 4A-4H illustrate relationships between data objects used in the network 10 of FIG. 1. FIG. 4A is a customer entity relationship (E/R) diagram. In FIG. 4A, a customer relationship object 200 is identified by a primary key (PK) relationship ID. The object 200 includes certain characteristics, such as date of last contact between the entity and the customer, date of creation, which refers to the date the relationship object was created for the customer, and authorization, which refers to the degree of access the customer has authorized from the company 12 and its business partners. The customer relationship object 200 is defined by other data objects that depend on the object 200.

An affiliation object 202 relates queries sent to one or many distributed databases to customers whose information is stored at one or more nodes on the network 10. The primary key (PK), or characteristic, of the affiliation object 202 is an affiliation ID. The affiliation ID identifies the list of nodes, or ring, on the network 10 from which the customer behavioral information can be retrieved and aggregated to form a dynamic and more exhaustive image of the customer. Other characteristics of the affiliation object 202 include the relationship ID from the customer relationship object 200, a short label, a long label, a start date, and end date, and remanence. The short label and the long label are descriptive titles for the affiliation. The short label is a shortened or truncated version of the long label. The start date and the end date indicate the time over which the affiliation may be valid with respect to the customer relationship.

The remanence characteristic refers to the right of the importing nodes to store indefinitely customer behavioral information related to the customer relationship identified by the relationship ID on the exporting node. Taking a specific example, if the automobile manufacturer 12b imports customer behavioral information from the credit card company 12a regarding the customer's attitude towards credit, the credit card company may not allow this information to be remanent in the manufacturer's database. This will not be done by forcing the automobile manufacturer 12b to erase the record, which the credit card company 12a has almost no way to enforce. Instead, each time the automobile manufacturer 12b queries the relationships of the credit card company 12a, and retrieves behavioral information, the exporting node of the credit card company 12a generates new identifiers for each individual customer, which will bar the automobile manufacturer 12b from synchronizing its previously acquired data. Hence, the previously acquired data will no longer be of use to the automobile manufacturer 12b, and will likely be discarded. In this sense, the information that is shared with the automobile manufacturer 12b is said to be non-remanent. This feature offers to the credit card company 12a the guarantee that the termination of the partnership with the automobile manufacturer 12b will leave in the automobile manufacturer's database no remanent nominative or behavioral information. Therefore, under the system for automated marketing and management of customer information usage rights, the circulated information is reputed to be non-remanent.

Dependent on the affiliation object 202 is ring object 203. The ring object 203 defines which companies 12 in the network 10 are able to synchronize relationships of customers that have subscribed to this affiliation. The ring object 203 is characterized by the affiliation ID and by a partner ID. The partner ID identifies companies 12 that share the same affiliation ID. The relationship between the affiliation ID and partner ID identifies companies 12 that may synchronize the customer information. Deleting a partner ID terminates the identified partner's capability to synchronize the customer information.

Many of the companies 12 in the network 10 may establish rewards programs for their loyal customers. Such rewards programs may provide reduced rate credit, reduced prices for products, cash back awards, special gifts, and other rewards. Reward object 204 defines rewards programs that the customer is eligible to participate in.

Communication object 205 defines communications channels through which the companies 12 may contact customers. The communication object 205 is characterized by channel ID, which specifies the type of communication channel through which the customer may be contacted. The channel ID may specify e-mail, telephone, regular mail, and any other means of communication with the customer. However, the channel ID does not specify an actual address of the customer. That is, if the channel ID specifies e-mail, the customer's e-mail address is not given. Similarly, if telephone is listed under channel ID, the customer's telephone number is not specified.

Communication object 205 is further characterized by frequency and resilience. frequency refers to the number of times the customer may be contacted per communication channel, and resilience specifies the time over which these contacts may occur through this communication channel. A frequency of three and a resilience of thirty days for the e-mail channel means the customer may be contacted a maximum of three time in thirty days by e-mail.

Socio-Demographic object 206 defines demographic and other related data that a company 12 may use when targeting products and services to customers. Such demographic data may include age, income, geographic location, marital status, and similar data.

Propensities object 207 specifies a rating for the customer in terms of the likelihood that the customer will purchase particular goods or services. The propensities object 207 is characterized by the relationship ID and a model ID. The model ID specifies a type of product or service. For example, the model ID may specify a credit model or a new automobile model.

Typologies object 208 characterizes customers according to specific customer segments, that are aggregated due to their homogeneous behaviors and hence their higher profitability. Different networks of partners may use different typologies. Such a typology may be, for example, “repetitive buyers.”

FIG. 4B shows the communication object 205 in more detail. The communication object 205 is defined by channel type object 210. The channel type object 210 is characterized by type code, short label and long label. The type code refers to the type of communication channel, such as e-mail, telephone, and mail, for example. The short label and the long label are short and long descriptive titles, respectively, for type of communication channel.

Channel ID 211 indicates a specific communication channel. For example, the automobile manufacturer's customer may be contacted by multiple communications means. One such communication channel may be e-mail and another may be regular mail. The channel ID 211 provides a specific identification of each of these two communication channels, for example.

Channel object 212 refers to a specific channel that is used for contacting the customer. The channel object 212 is characterized by a descriptor that describes the parameters of the channel, short and long labels that provide short and long descriptive titles, and template ID. The template ID refers to a company-specific format that is used for contacting the customer. Using the example of the automobile manufacturer 12b and the credit card company 12a, the customer may be an original customer of the automobile manufacturer 12b and the credit card company 12a may desire to contact the customer by e-mail to provide credit services. The template ID specifies that the format of the e-mail to be sent by the credit card company 12a to the customer must follow a specific format established by the automobile manufacturer 12b.

FIG. 4C provides further details of the propensities object 207. The propensities object 207 is defined by propensity model object 215. Propensity model object 215 indicates that the customer may have more than one propensity model, and provides an identification of a specific propensity model, for example the propensity model for cars. The propensity model object 215 is characterized by rating and personalization criteria. The rating refers to a likelihood that the customer will purchase a particular good or service. The rating could be subjective, and state a simple likelihood (e.g., low, medium, high). Alternatively, the rating could be more objectively determined based on individual habits, demographic features, and past purchasing events of the customer. For example, the customer's marital status may have changed from single to married, income may have increased, and last automobile purchased may have been five years ago, or, alternatively, the customer's automobile may be leased, with the lease set to expire in the near future. Given these facts, the customer's rating could be set at a high level (e.g., greater than 80 percent) indicating that the customer may be considering acquiring a new automobile.

Personalization criteria refers to data that the company 12 may use to personalize an offer for a product or a service to the customer, in order, for example to improve his or her satisfaction or to influence him or her into buying the product or service. For example personalization criteria may indicate the customer prefers red minivans bought on credit with no money down. The automobile manufacturer 12b could then structure an offer to the customer that includes one or more of these features. As indicated, the propensity model object 215 for a specific customer may include many personalization criteria.

Once a company, such as the credit card company 12a, has identified potential customers from another company's customer database, such as the customer database of the automobile manufacturer 12b, a mechanism is used to allow the credit card company 12a to contact the identified potential customers. For example, the credit card company 12a may query the customer database of the automobile manufacturer 12b, and may identify 1,000 individuals whose propensity data indicates they each would be interested in obtaining credit services that the credit card company 12a offers. The identified potential customers are referenced by the relationship object 200, meaning that all the data concerning the identified potential customers is anonymous at this stage. To actually contact specific individuals, the credit card company 12a will need to acquire usage rights on these customers' information, but will at no time gain access to their nominative information. The customer information usage rights will be brokered by the node owned by the automobile manufacturer 12b to the node owned by the credit card company 12a. These usage rights are brokered in the form of anonymous, digitally signed coupons. FIG. 4D shows a coupon object 216 used in the network 10 to allow partner companies, such as the automobile manufacturer 12b and the credit card company 12a to contact the identified potential customers.

A coupon object 216 basically defines the usage rights for a customer's information and by doing so, defines the modalities of the contact with that customer. For example, the credit card company 12a will have the right to contact each customer once, by e-mail, over a period ranging from the first of September to the sixteenth of September. The coupon object 216 is characterized by client campaign and campaign ID. The client campaign and campaign ID identify a specific marketing plan from a company. Importing node ID identifies the company that receives customer data from another company's database. Exporting node ID identifies the company that provides the customer data. The channel ID was previously defined with respect to FIG. 4B. The start date and end date refer to the start and end of a specific campaign as defined by the campaign ID. Product ID identifies a product or service that is being marketed using the campaign. Probability is an expected transformation rate, that is, the expected percentage of customer contacts that effectively translate into a transaction. Probability certainty is the statistical likelihood that the expected transformation rate is correct. A probability of 50 percent and a probability certainty of 95 percent means that the expected transformation rate is 50 percent, and there is a 95 percent probability that the 50 percent transformation rate will correctly predict the actual number of customer contacts that result in purchases. Propensity, as discussed previously with respect to FIG. 4C relates to the likelihood, in the form of a rating, that a specific customer will purchase goods or services. Propensity certainty is the likelihood that the propensity is accurate. Personalization vector relates to personal information stored by the exporting node for the customer. The personalization vector may include behavioral data, and a location at which these data are stored. Price is the cost to the importing node for using the customer's information. Status refers to whether the importing node has used the coupon. For example, the importing node may be authorized to contact the customer three times between the start date and the end date. The status field indicates the number of authorized contacts, and whether any of these contacts was previously used, thereby reducing the remaining allowed contacts. Date of issue is the date on which the coupon issues.

FIG. 4E illustrates a campaign object 217. The campaign object 217 is characterized by the short and long labels, importing node ID, exporting node IDs, channel ID, contacts, query, start and end dates and status. The short label and the long label are short and long descriptive titles, respectively, for the campaign object 217. The campaign object 217 has the specificity of being a distributed object. Which means that he references resources that belong to other nodes on the network. This also means that the resources that are referenced by the campaign object 217 must be kept track of on the importing node as well on the various exporting nodes, and that this tracking data should be synchronized on all nodes before modifying the object. Accordingly, the campaign object 217 can exist under three states, which are a “standalone” state, a “descriptive” state and a “loaded” state. In the standalone state, the campaign object 217 does not point to any group of campaign descriptors (such as the campaign descriptor 220 shown in FIG. 4F) nor to any group of coupons 216 as shown in FIG. 4D. The campaign object 217 is characterized by importing node ID which is identifies the node on which the object has been instantiated. Exporting nodes, under the standalone state, identifies the nodes that are planned to be queried. The channel ID specifies the type of communication channel through which the customer will be contacted for this campaign. The contacts identifies the number of contacts that will occur during the campaign. The query stores the full extent of the query developed to target the prospective customers. The start date and the end date specify the beginning and the end of the campaign. When the fields of the campaign object 217 are sufficiently defined under the standalone state, the campaign object 217 will be upgraded to the descriptive state, which purpose is to describe precisely the available relationships on the various exporting nodes, no storing however the full extent of the possible coupons.

The descriptive state is illustrated in FIG. 4F, which is another view of the campaign object 217, showing a campaign descriptor object 220, which further defines the campaign object 217. The campaign descriptor 220 is identified by the descriptor ID. To upgrade the campaign object 217 to the descriptive state, a copy of the campaign parameters is instantiated and sent to each exporting node in the form of a campaign descriptor object 220. The campaign descriptor object 220 is characterized by campaign ID, importing node ID, exporting node ID, channel ID, contacts, query, start date and end date, status, contract ID and mapping matrix. The campaign descriptor 220 is characterized by the campaign ID, which correlates the campaign descriptor 220 to a corresponding campaign 217. The importing node ID identifies the node on which the originating campaign object 217 has been initially instantiated. Channel ID, contacts, query, start date and end date are simply a copy of the parameters of the originating campaign object 217. The exporting node ID identifies the node to which the campaign descriptor object 220 has been sent. The status reflects the status of the campaign descriptor object 220 with respect to the exporting node. The contract ID refers to a contractual document that regulates rules between the partners (i.e., companies 12a and 12b) regarding sharing of customer information, confidentiality agreements, pricing, and other matters. As noted above, the campaign refers to a certain number of contacts, or customers, that the importing node may contact. This number of contacts ultimately will match a number of coupons issued by the exporting node. However, the potential number of contacts may be very large, on the order of tens to hundreds of thousands. Conventional mechanisms for handling data are not efficient when the data are of this volume. Furthermore, transmitting this volume of data over the network 10 may be very time consuming, and is prone to interruption and error. To compensate, an n-dimensional mapping matrix determines how the available relationships that have been selected in the exporting nodes (in the example used herein, in Node A) are distributed with respect to n qualifying criteria. Once the query has been executed on the exporting node, the mapping matrix is populated with the content of the exporting node behavioral database. The campaign descriptor object 220 is subsequently sent to the importing node for synchronization of the campaign object 217. Once all the campaign descriptor objects 220 have been received on the importing node, the mapping matrices will be compared, and the best subsets of contacts will be selected from the total number of contacts identified by the campaign and updated to reflect the subsets of the exporting nodes databases that will be subject to the extraction of customer information usage rights in the form of coupons. Once the campaign object 217 is sufficiently defined under the descriptive state, it can then be upgraded to the loaded state.

Referring to FIG. 4G, to upgrade the campaign object 217 to the loaded state, the updated campaign descriptor objects 220 with the updated mapping matrices are sent back to the exporting nodes. The exporting nodes use the campaign descriptor objects to generate the corresponding coupon object 216. A first instance of the coupons objects 216 is stored on the exporting node for tracking purposes and a second instance is sent to the importing node, where the coupons object 216 are stored and further define the campaign object 217 through a population association 218.

FIG. 4H illustrates the relationship object 200 in more detail. As shown in FIG. 4H, the relationship object 200 is further defined by customer object 222. The customer object 222 includes the nominative data for a specific customer, as indicated.

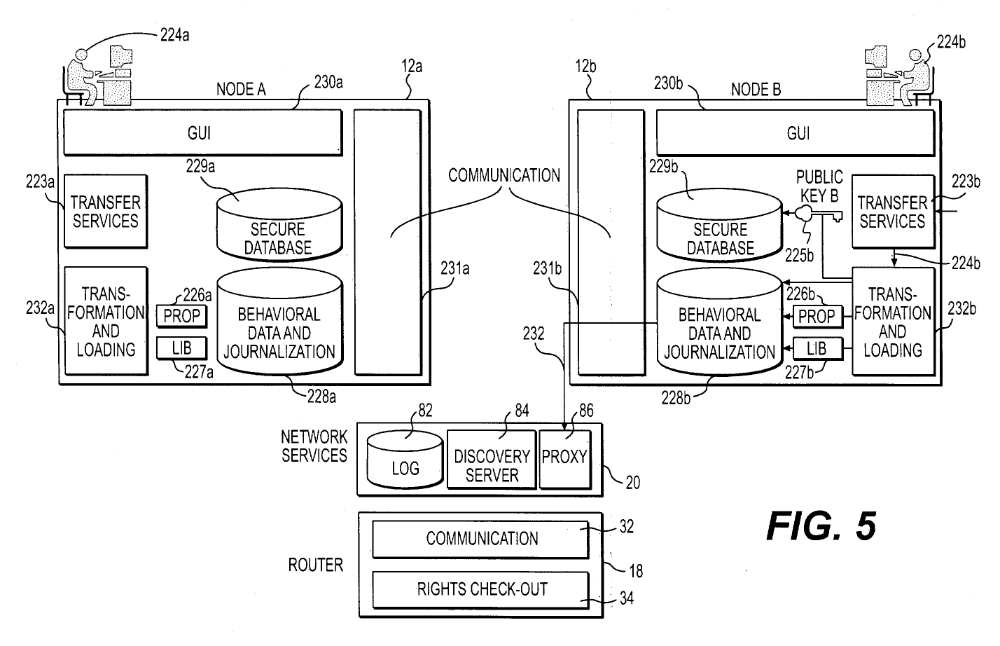

FIGS. 5-13 illustrate processes and data flows associated with automated marketing and customer information usage rights management. FIG. 5 illustrates company 12b (the automobile manufacturer, at Node B) and company 12b (the credit card company, at Node A). Also shown are the network service center 20 and the router 18. Nodes A and B each include a transfer services module 223, propensity models 226, calculus library 227, database 228, secure database 229, graphical user interface (GUI) 230, communication interface 231, and transformation and loading module 232. Also shown for Node B is public key B 225b.

As the companies 12a and 12b operate, each company will receive data related to its own customers. At Node B, the transfer services module 223 receives customer data from the company's information systems 150 (see FIG. 3). The data are then processed through transformation and loading module 232b, which segregates nominative data from behavioral data and packages the behavioral data. The nominative data are encrypted with node B's public key B 225b, and are stored in the secure database 229b. The behavioral data are either directly stored into the database 228b or, if needed, are processed through the propensity model 226b and/or the calculus library 227b, and are stored in the database 228b. Once the storage process is complete, the description 232 of the content of the databases is sent through the communication interface 231b to the discovery server 84.

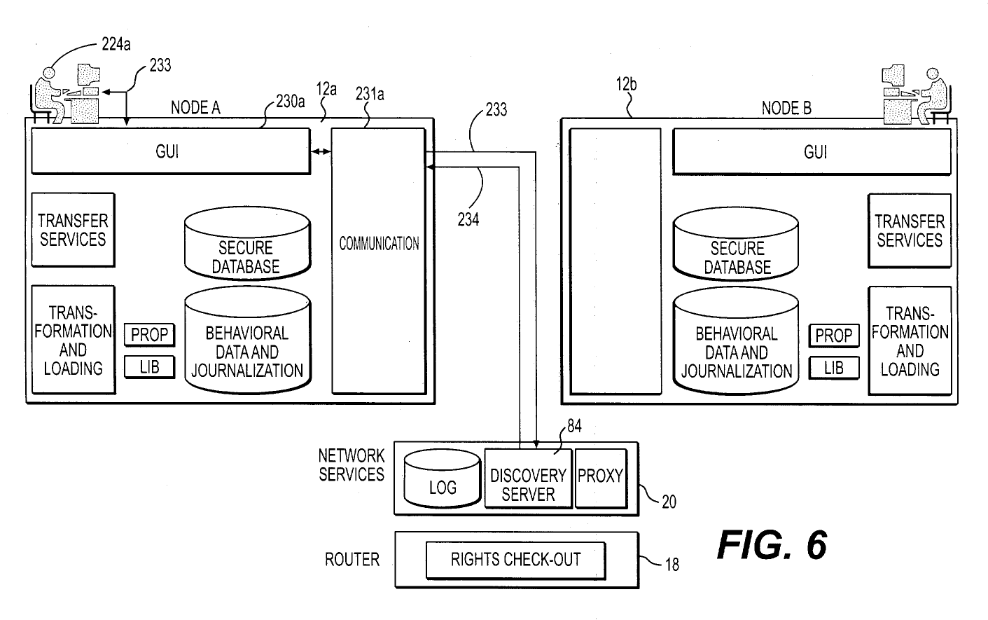

At some point during its operation, company 12a (the credit card company, Node A) develops a marketing campaign to sell its credit services. Referring to FIG. 6, a user 224a at company 12a desires to market its credit services to as wide a customer base as possible, and so initiates a discovery action 233 with its partners in the network 10. At Node A, the discovery action 233 is sent from the GUI 230a through the communications interface 231a. From the communications interface 231a, the discovery request 233 is sent to discovery server 84 at the network services center 20. The discovery server 84 sends back a description 234 of the network 10 according to the authorizations of Node A. The GUI 230a then retrieves the network description 234 through the communication interface 231a and presents the network description to the user 224a at Node A.

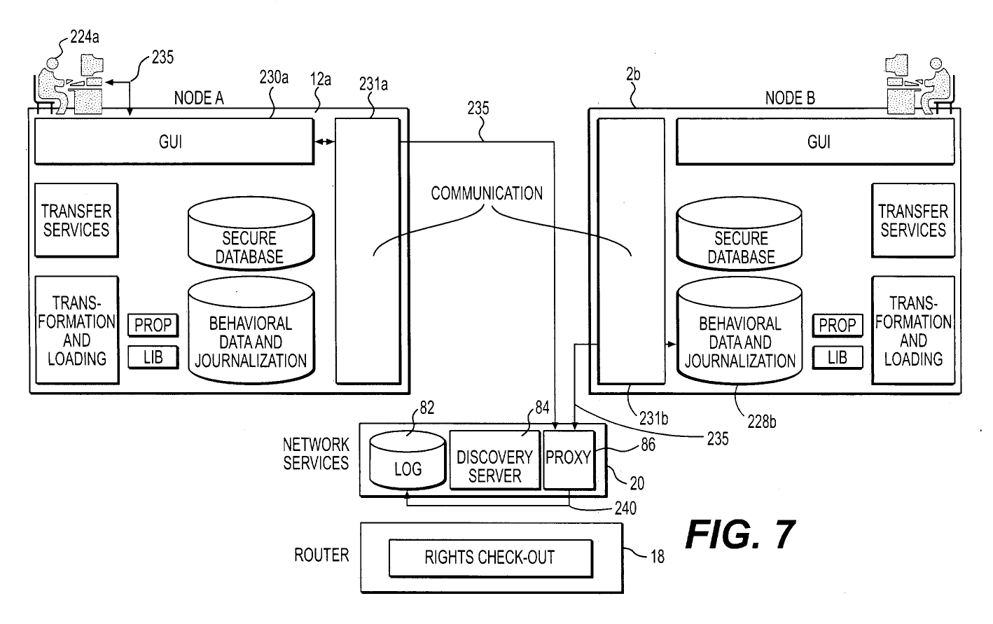

Once the user 224a at Node A has received the network description 234, the user 224a will attempt to extract behavioral information from its partners' databases according to the network description 234. In FIG. 7, the user 224a at Node A, using the GUI 230a, prepares a campaign 217. Campaign descriptors 220 are then sent 235 through the communications interface 231a to proxy server 86 at the network service center 20. The proxy server 86 logs the content 240 of the campaign descriptors 220 into a log database 82. The proxy server 86 then dispatches 235 the campaign descriptors 220 to corresponding nodes of the network 10, such as Node B (company 12b). The nodes receiving the campaign descriptors 220 are the exporting nodes. At Node B (company 12b, and at all other authorized nodes as defined in the network description 234), the query contained in the campaign descriptors 220 is executed on the node's database 228b.

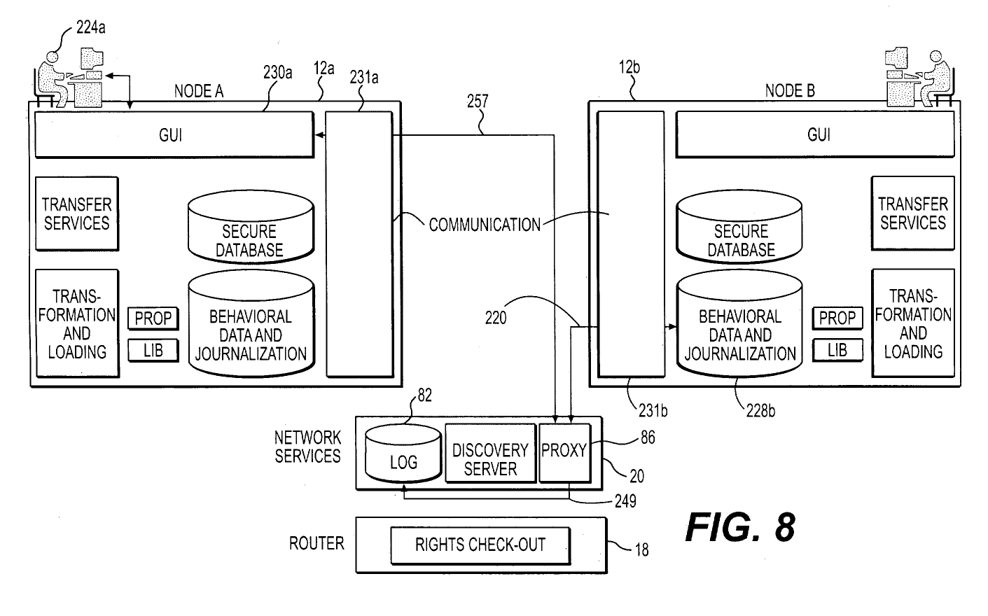

Once the query contained in the campaign descriptors 220 is received at the exporting nodes of the network 10, the query is executed on the node's behavioral data, and the result of the query is used to update the campaign descriptors 220, notably the mapping matrices of the campaign descriptors 220, to reflect the distribution of the relationships available from the node's behavioral database 228b. In FIG. 8, the database 228b at Node B executes the query contained in the campaign descriptors 220 from Node A. The execution examines available relationships 200 based on communications channels 212, and the propensities 207 of the relationships 200 to purchase Node A's services. Execution of the query contained in the campaign descriptor 220 results in an update of the campaign descriptor 220, which is routed through the communication interface 231b to the proxy server 86. The proxy server 86 generates a descriptor log 249, which is then logged in the database 82. The proxy server 86 routes the descriptor 220 to Node A (the querying node) through Node A's communication interface 231a. Finally, the descriptor 220 is accessed via the GUI 230a.

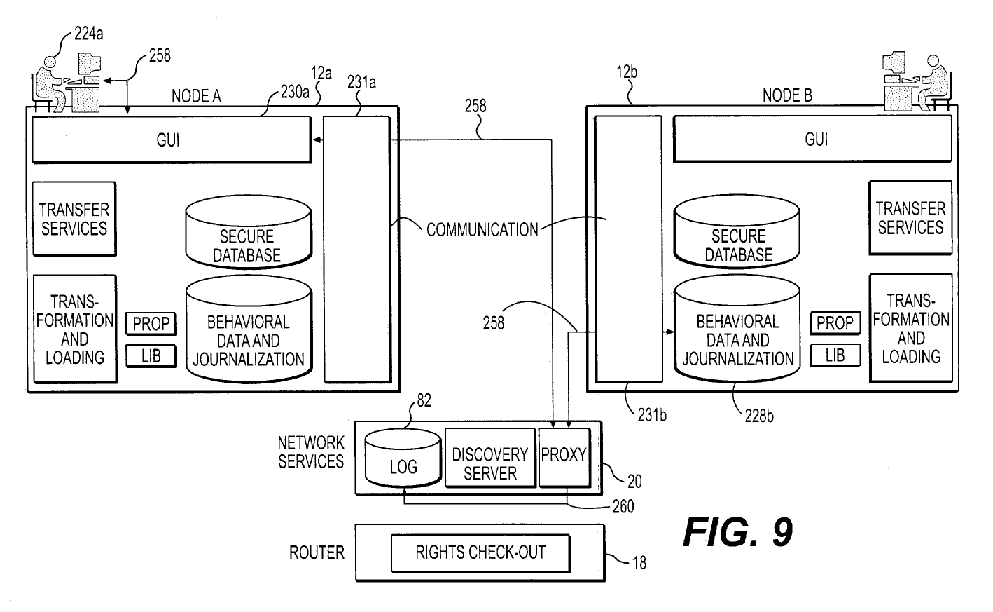

With the descriptors returned from the exporting nodes by way of the network services center 20, the user at the importing node can update the campaign 217 for its service. Specifically, and referring to FIG. 9, using the network description 234 and the returned campaign descriptors 220 from the exporting nodes in the network 10, the user 224a at Node A updates the campaign 217 through the GUI 230a or through an automated process by selecting the best subsets in the mapping matrices. Consecutively, the campaign descriptors 220 are updated. The updated campaign descriptors 220 are then sent 258 to the proxy server 86 through the communications interface 231a. The proxy server 86 creates a new descriptor log 260, and logs the descriptor log 260 in the log database 82. The proxy server 86 then sends 258 the updated campaign descriptors 220 to the corresponding node(s) (in his example, Node B) through the communications interface 231b.

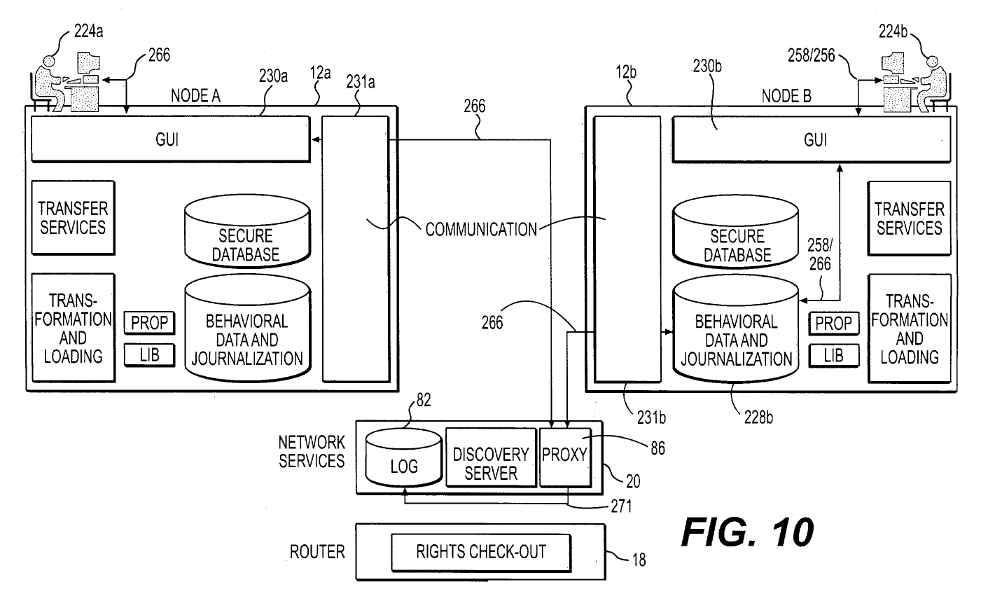

Once the updated campaign descriptors are received by the exporting node's databases, the exporting node campaign validation manager 224b may validate, modify, or revoke the campaign 217. The campaign validation manager 224b may also revoke the campaign 217 at any time during its run time. More specifically, and referring to FIG. 10, at Node B, the campaign validation manager 224b views the campaign descriptor 220 using the GUI 230b, and issues a status modification message 266 to the database 228b. The status modification message 266, in this example, may simply authorize importing node A to acquire Node B's customer information usage rights. The status modification message 266 is sent to the proxy server 86. The proxy server 86 creates a status log 271 and logs the status log 271 in the log database 82. The proxy server 86 also sends the status modification message 266 to the requesting node (Node A) through the communications interface 231a. The status modification message 266 is then presented to the user 224a through the GUI 230a.

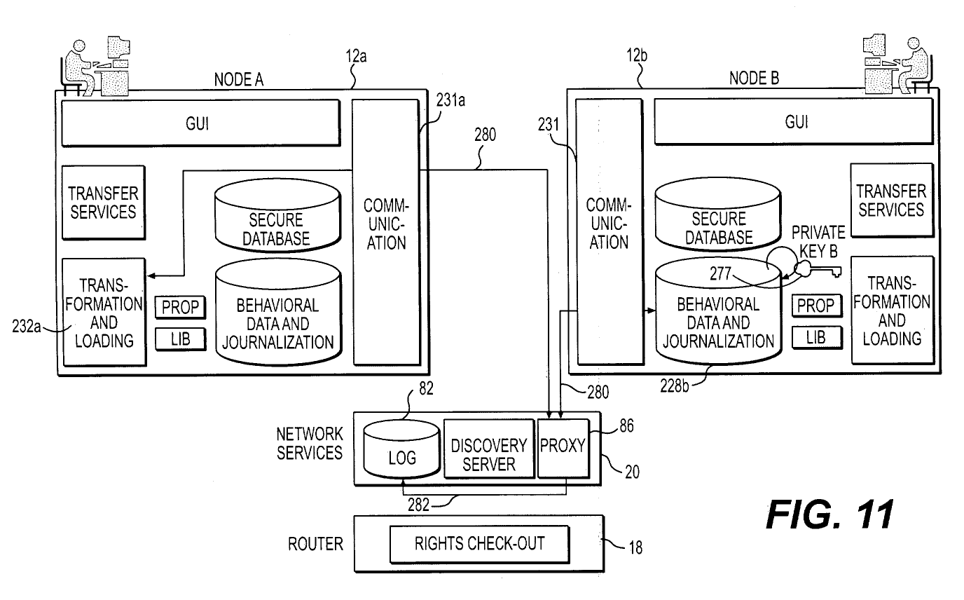

In FIG. 11, at the exporting node (Node B), the coupons 216 corresponding to the campaign descriptor 258 are then generated from Node B's database 228b. The coupons 216 comprise the customers' behavioral information as well the usage rights corresponding to the campaign descriptor 220. The behavioral information and the usage rights are then digitally signed using the Node B's private key B 277. The digitally signed coupons 216 are then sent 280 to the proxy server 86 through the communications interface 231b. The proxy server 86 creates a coupon log 282, and stores the coupon log 282 in the log database 82. The proxy server 86 then sends 280 the coupons 216 to the requesting node A. The signed coupons 280 may then be made available to Node A's information services 150 through the transfer services module 223a.

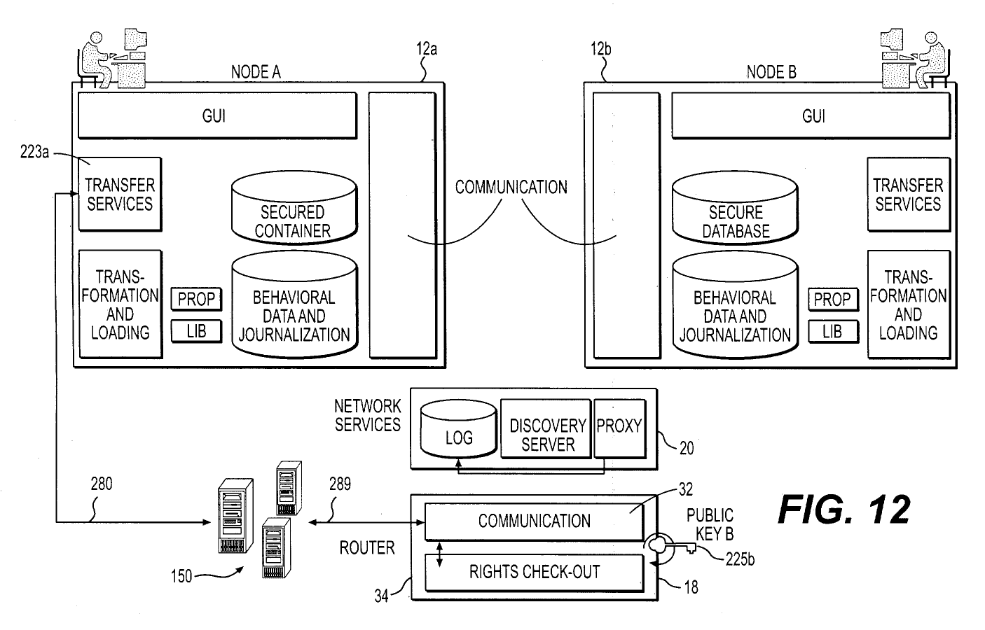

Once Node A has received the signed coupons 216, the information system 150 of Node A may store the coupons 216, and may send the coupons 216 to the network service center 20 to enable delivery by the router of the direct marketing message to the customer. Referring to FIG. 12, the information system 150 of Node A retrieves 280 the signed coupons from the transfer services module 223a. The information system 150 stores the coupons 216 in any company database suitable for storing customer information, for example the company's data warehouse or the company's campaign management tool. Once the company 12a wants to use the coupons 216, the company 12a sends them together with the direct marketing message to be delivered to the appropriate router, which receives it through the communication interface 32. The rights check out module 34 verifies the signatures of the signed coupons 216 using public key B 225.

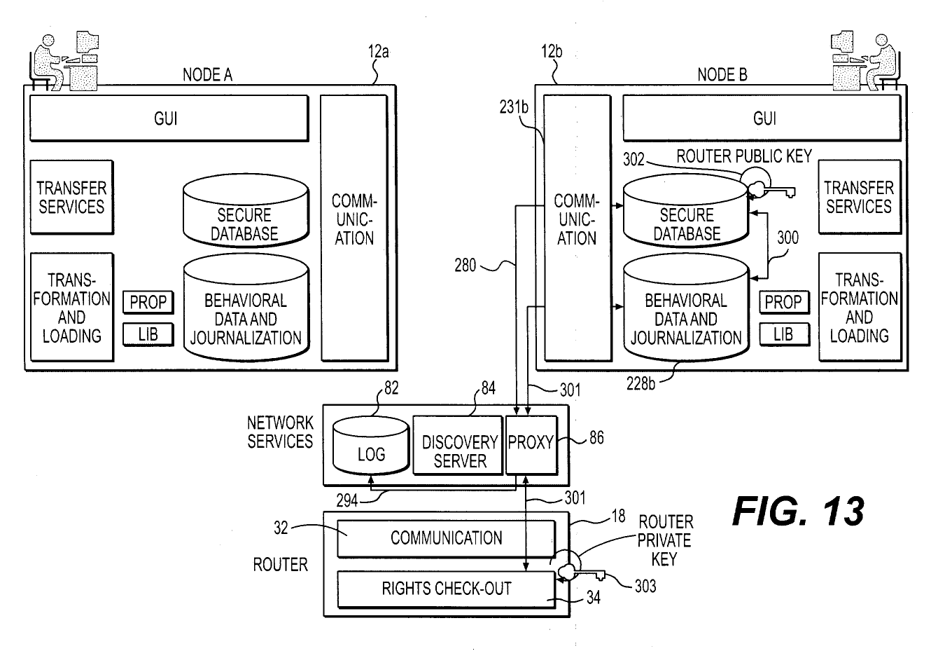

Referring to FIG. 13, once the rights check out module 34 has verified the signature and the usage rights on the signed coupons 216, a request 301 for retrieval of the nominative information on the coupons 216 is sent to the proxy server 86. The proxy server 86 sends the request 301 for retrieval of the nominative information to the Node B main database 228b. The validity of the coupons 216 is verified against the instance of the same coupons that has been stored in the behavioral and journalization database 228b. If the coupons 216 are valid, the coupons 216 are matched 300 to nominative data in the secure database 229b. Such nominative data are stored in the customer profile 222, which is encrypted with the router public key 302. Once matched, the use of the coupons 216 is recorded in the database 228b so as to prevent their reuse. Consecutively, the nominative information is extracted from the secure database and encrypted with the router public key 302. Consecutively the encrypted nominative information is sent to the proxy server 86. The proxy server creates a receipt log 294, and stores the receipt log 294 in the log database 82. The matched nominative data are then sent to the rights check out module 34 through the communication interface 32. The rights check out module 34 then decrypts the signed coupons 280 using the router private key 303. Consecutively the router 18 delivers the direct marketing message to the customer.

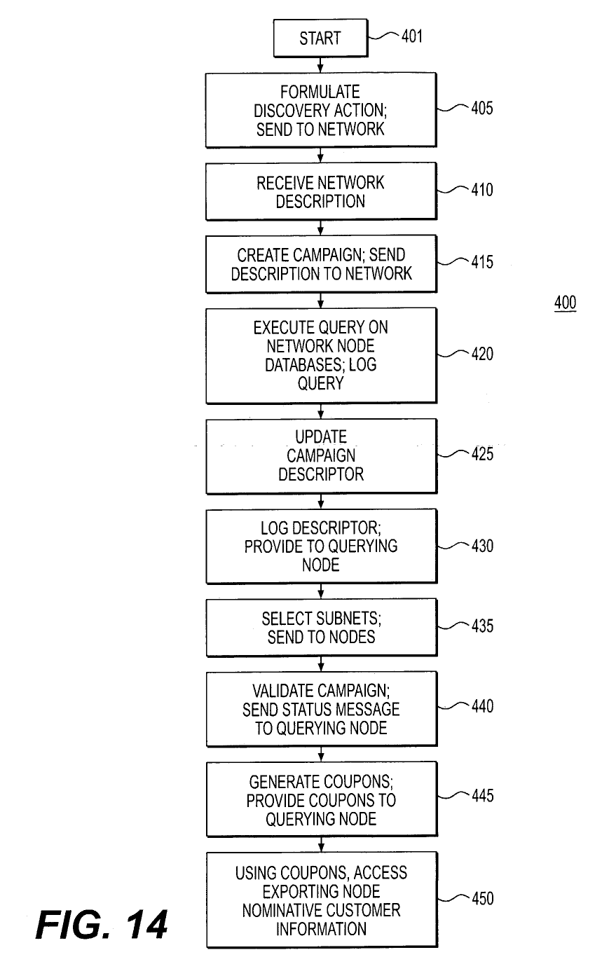

FIG. 14 is a flowchart illustrating a method 400 for automated marketing and customer information usage rights management. The method 400 begins with block 401. In block 405, the user 224a, using the GUI 230a, formulates a discovery action 233, and sends the discovery action 233 to the network service center 20, where the discovery action is distributed to nodes in the network 10. Next, in block 410, the network services center 20 receives network descriptions from specific suitable nodes. The network description is then forwarded to Node A. In block 415, the user 224a formulates a campaign 217, based on the network description, and sends the campaign descriptors 220 to the network services center 20. The network services center 20 then forwards the campaign descriptors 220 to Node B. In block 420, Node B executes the query 235 on Node B's database 228b, and the proxy server 86 creates and stores a log of the query 235 in the log database 82.

In block 425, the database 228b updates the campaign descriptor, and Node B provides the campaign descriptor to the network services center 20. In block 430, the proxy server 86 generates a log descriptor, stores the descriptor in the log database 82, and send the descriptor to Node A. In block 435, the user 224a at Node A selects the appropriate subsets from the campaign descriptors, and sends the updated campaign descriptor to Node B.

In block 440, Node B validates the campaign, and sends a status message to the networks services center 20. The network services center 20 sends the status message to Node A. In block 445, Node B generates coupons 216 for the campaign, and provides the coupons 216 to the network services center 20. From the network services center 20, the coupons may be provided to Node A. Finally, in block 450, Node A, using the coupons 216, access customer nominative information from the secure database 229a at Node A.

The foregoing description of the embodiments is for purposes of illustration and description. The description is not intended to be exhaustive or to be limiting to the precise form disclosed. Many modifications and variations are possible in light of the above teaching. The scope of the invention is not to be limited by the detailed description. Since many embodiments of the invention can be made without departing from the spirit and scope of the invention, the invention resides in the claims hereinafter appended.

I claim:

1. A method for automated direct marketing in a network comprising a network service center including a discovery service, a proxy server, and a log database, the method, comprising:
at a first node in the network:
retaining customer information, the customer information comprising nominative data and behavioral data, the nominative data providing identities of specific customers of a company and privacy data related to the specific customers, the behavioral data comprising customer propensity information;
providing the behavioral data to a second node in the network; and
locating the nominative data associated with the provided behavioral data.

2. The method of claim 1, further comprising at the first node:
summarizing the behavioral data; and
publishing the behavioral data to the discovery service.

3. The method of claim 1, further comprising at the first node:
packaging the behavioral data for selected customers; and
routing the packaged behavioral data to the proxy server.

4. The method of claim 1, further comprising:
creating usage coupons, the usage coupons describing rights of use to the nominative data associated with the provided behavioral data; and
routing the usage coupons to the proxy server.

5. The method of claim 4, further comprising:
verifying the usage coupons are valid;
updating conditions of the usage coupons; and
logging the usage coupons in the log database.

6. The method of claim 1, further comprising at the second node:
formulating a behavioral data discovery request; and
sending the discovery request to the proxy server.

7. The method of claim 6, further comprising logging the discovery request.

8. The method of claim 6, further comprising:
in response to the discovery request, receiving discovery responses from the first node and from exporting nodes in the network;
aggregating the responses; and
sending the aggregated responses to the second node, wherein the second node is an importing node.

9. The method of claim 8, further comprising at the second node, filtering the received aggregated responses.

10. A system for automated direct marketing in a network comprising nodes and a service center, the service center including a proxy server, a discovery server, and a log database, the system comprising:
a first data structure comprising behavioral data of customers;
a second data structure comprising nominative data of the customers, wherein the nominative data provides identities of specific customers of a company and privacy data related to the specific customers, and the behavioral data comprises customer propensity information;
a discovery request generator that analyzes the behavioral data and generates a network description; and
coupons used to match the behavioral data to the nominative data.

11. The system of claim 10, further comprising a propensity model that characterizes, categorizes, and packages the behavioral data, wherein the behavioral data are available on the network.

12. The system of claim 10, further comprising a communication interface that routes the packaged behavioral data and the coupons to the proxy server.

13. The system of claim 10, wherein the coupons comprise a description of usage rights in the nominative data.

14. The system of claim 13, further comprising a validation manager that validates the coupons, wherein the validated coupons are logged in the log database.

15. The system of claim 14, wherein the validation manager comprises a status modification message that changes a status of data exchange between nodes in the network.

16. The system of claim 15, wherein the status modification message comprises an authorization to acquire the usage rights.

17. A system for automated direct marketing in a network comprising nodes and a service center, the service center including a proxy server, a discovery server, and a log database, the system comprising:
at a first node in the network:
formulating a discovery action, the discovery action requesting a description of the network, the description identifying nodes in the network from which the first node imports customer information;
receiving the network description of the network;
executing a query directed to the identified nodes based on the received network description, the query generating a campaign descriptor for each identified node;
creating a campaign based on the campaign descriptor;
sending the campaign to the identified nodes, the campaign generating coupons at the identified nodes;
receiving the coupons; and
extracting customer nominative data from the identified nodes using the coupons.

18. The method of claim 17, wherein the customer information includes behavioral data and the nominative data, and wherein the behavioral data comprises the customer propensity data.

19. The method of claim 17, wherein the customer propensity data comprises a likelihood that a customer will purchase a product or a service.

20. The method of claim 17, wherein the customer nominative data are privacy protected at the identified nodes.

21. The method of claim 17, wherein the coupons are signed with private keys of the identified nodes.

22. The method of claim 17, wherein in the step of extracting the customer nominative data using the coupons comprises sending the coupons to a network service, the network service verifying rights of the first node to the customer nominative data.

23. The method of claim 22, further comprising receiving, at the first node, from the network service, authorization to access the customer nominative data.

24. A method for automated marketing with customer privacy in a network comprising an importing node and exporting nodes, wherein one or more of the exporting nodes comprises customer information desired by the first node for use in automated marketing of a product or service, the method, comprising:
at the importing node:
formulating a discovery action, the discovery action requesting a description of the network, the description identifying exporting nodes in the network from which the importing node imports the customer information,
receiving the network description of the network,
formulating a query directed to the identified exporting nodes, the query requesting customer behavioral data, the query generating a campaign descriptor for each identified exporting node,
receiving the campaign descriptor,
creating a campaign based on the campaign descriptor,
sending the campaign to the identified exporting nodes, the campaign generating coupons at the identified exporting nodes,
receiving the coupons, and
extracting customer nominative data from the identified exporting nodes using the coupons;
at each of the exporting nodes:
receiving the query,
based on the query, extracting the customer behavioral data from a customer behavioral data database, and
based on the extracted customer behavioral data, generating the campaign descriptor; and
at each of the identified exporting nodes:
sending the campaign descriptor to the network service,
receiving the campaign,
validating the campaign,
generating the coupons, and
sending the coupons to the network service.

25. The method of claim 24, wherein the customer information includes behavioral data and nominative data, and wherein the behavioral data comprises customer propensity data.

26. The method of claim 25, wherein the customer propensity data comprises a likelihood that a customer will purchase a product or a service.

27. The method of claim 25, wherein the nominative data are privacy protected at the exporting nodes.

28. The method of claim 24, wherein the coupons are signed with private keys of the identified exporting nodes.

29. The method of claim 24, further comprising extracting the customer nominative data using the coupons, comprising sending the coupons to the network service, the network service verifying rights of the importing node to the customer nominative data.

30. A computer readable medium, suitably programmed to provide automated marketing with customer privacy, the programming operable at a first node to execute the steps of:
formulating a discovery action, the discovery action requesting a description of the network, the description identifying nodes in the network from which the first node imports customer information;
receiving the network description of the network;
formulating a query directed to the identified nodes, the query requesting customer propensity data, the query generating a campaign descriptor for each identified node;
receiving the campaign descriptor;
creating a campaign based on the campaign descriptor;
sending the campaign to the identified nodes, the campaign generating coupons at the identified nodes;
receiving the coupons; and
extracting customer nominative data from the identified nodes using the coupons.

31. The computer readable medium of claim 30, wherein the customer information includes behavioral data and the nominative data, and wherein the behavioral data comprises the customer propensity data.

32. The computer readable medium of claim 30, wherein the customer propensity data comprises a likelihood that a customer will purchase a product or a service.

33. The computer readable medium of claim 30, wherein the customer nominative data are privacy protected at the identified nodes.

34. The computer readable medium of claim 30, wherein the coupons are signed with private keys of the identified nodes.

35. The computer readable medium of claim 30, wherein in the step of extracting the customer nominative data using the coupons comprises sending the coupons to a network service, the network service verifying rights of the first node to the customer nominative data.

36. The computer readable medium of claim 35, further comprising receiving, at the first node, from the network service, authorization to access the customer nominative data.

37. A system that provides automated marketing with customer privacy, comprising:
at a first node in a network:
a user interface that generates messaging used to extract information from other nodes in the network,
a first propensity model that generates probabilities related to purchasing products and services by customers of the first node,
a first secure database that stores first node customer nominative data, and
a first behavioral database that stores first node customer behavioral data; and
a network service that receives the generated messaging, the network service, comprising:
a proxy server that processes selected ones of the received messaging and generates events, and
a log database that stores the generated events.

38. The system of claim 37, wherein the network service further comprises a discovery server, the discovery server receiving a discovery request message from the node, the discovery server returning a network description in response to the received discovery request.

39. The system of claim 38, wherein the network description identifies nodes in the network from which the first node can extract customer information.

40. The system of claim 37, wherein the other nodes each comprise:
a secure database that stores customer nominative data;
a behavioral database that stores customer behavioral data; and
a propensity model that generates purchasing probabilities related to customers of the node.

41. A computer readable medium comprising a data structure for storing customer information related to automated marketing in a network having importing nodes and exporting nodes, the data structure, comprising:
a relationship object defining relationships between the importing nodes and the exporting nodes, and including authorizations to access customer information;
a communication object defining communication channels available to contact customers of the exporting nodes and the importing nodes;
a propensity object defining:
a probability of purchasing a product or service by a customer, and customer personalization criteria;
a coupon object identifying a specific marketing plan for an importing node;
a campaign object defining the specific marketing plan; and
a consumer object including consumer private information.

42. The data structure of claim 41, wherein the coupon object comprises:
a customer campaign identification that correlates customers to campaigns;
an importing node identification that identifies a node receiving the consumer private information;
an exporting node identification that identifies a node providing the consumer private information;
a campaign start date and end date that define the time for execution of the campaign; and
a probability that a contact with a consumer will result in a purchase of the product or service.
